(19) United States
(12) Patent Application Publication
(10) Pub. No.: US 2013/0120208 A1
(43) Pub. Date: May 16, 2013

(54) Auxiliary Antenna Device, Antenna Set, and Handheld Radio Communication Device

(71) Applicants: Andrei Kaikkonen, Jarfalla (SE); Peter Lindberg, Uppsala (SE); Stefan Irmscher, Sollentuna (SE)

(72) Inventors: Andrei Kaikkonen, Jarfalla (SE); Peter Lindberg, Uppsala (SE); Stefan Irmscher, Sollentuna (SE)

(21) Appl. No.: 13/736,260

(22) Filed: Jan. 8, 2013

Related U.S. Application Data
(63) Continuation of application No. PCT/EP2010/061088, filed on Jul. 30, 2010.

(51) Int. Cl. H01Q 25/00; H01Q 9/06

(52) U.S. Cl. CPC H01Q 25/00; H01Q 9/065
USPC 343/803; 343/700 MS; 343/893; 343/793

(57) ABSTRACT

In an exemplary embodiment, there is an auxiliary antenna device for a handheld radio communication device including ground plane means extending in a main direction and a main antenna device having an antenna element operatively coupled to the ground plane means and configured for reception of signals at a selected frequency and polarized essentially in the main direction. The auxiliary antenna device includes a balanced or self-balanced antenna element arrangement, an amplifier, and an output port. The balanced or self-balanced antenna element arrangement is configured for reception of signals at the selected frequency and polarized in a direction essentially orthogonal to the main direction. The amplifier is operatively connected to the balanced or self-balanced antenna element arrangement and configured for amplification of signals received by the balanced or self-balanced antenna element arrangement. The output port is operatively connected to the amplifier and configured to output signals amplified by the amplifier.

### CROSS-REFERENCE TO RELATED APPLICATION

This application is a continuation of PCT International Patent Application No. PCT/EP2010/061088 filed Jul. 30, 2010, published as WO 2012/013240 on Feb. 2, 2012. The entire disclosure of the above application is incorporated herein by reference.

### FIELD

The present disclosure relates generally to the field of radio communications and particularly to auxiliary antenna devices for use in handheld radio communication devices, as well as to antenna sets and handheld radio communication devices comprising main and auxiliary antenna devices.

### BACKGROUND

This section provides background information related to the present disclosure which is not necessarily prior art.

Mobile communication at high data rates demands the introduction of advanced radio communication link systems or equipment that better comply to the nature of radio wave propagation properties of wireless channels than communication at lower rates. One way to solve this is to introduce two or more antennas at either or both of the receiver and transmitter ends of a communication network. Antennas applied for these types of solutions are often termed MIMO (Multiple Input Multiple Output) or MISO (Multiple Input Single Output) antennas. The configuration of such antennas has to offer some degree of independence, i.e., isolation, or un-correlation between the antennas. This is normally accomplished by physical separation of the antennas.

### SUMMARY

This section provides a general summary of the disclosure, and is not a comprehensive disclosure of its full scope or all of its features.

Exemplary embodiments are disclosed of auxiliary antenna devices for use in handheld radio communication devices. Exemplary embodiments are also disclosed of antenna sets comprising main and auxiliary antenna devices and handheld radio communication devices comprising such antenna sets.

In an exemplary embodiment, there is an auxiliary antenna device for a handheld radio communication device including ground plane means extending in a main direction and a main antenna device having an antenna element operatively coupled to the ground plane means and configured for reception of signals at a selected frequency and polarized essentially in the main direction. The auxiliary antenna device includes a balanced or self-balanced antenna element arrangement, an amplifier, and an output port. The balanced or self-balanced antenna element arrangement is configured for reception of signals at the selected frequency and polarized in a direction essentially orthogonal to the main direction. The amplifier is operatively connected to the balanced or self-balanced antenna element arrangement and configured for amplification of signals received by the balanced or self-balanced antenna element arrangement. The output port is operatively connected to the amplifier and configured to output signals amplified by the amplifier to a radio receiver of the handheld radio communication device.

Further areas of applicability will become apparent from the description provided herein. The description and specific examples in this summary are intended for purposes of illustration only and are not intended to limit the scope of the present disclosure.

### DRAWINGS

FIG. 1 illustrates, schematically, a main PCB of a handheld radio communication device, a main antenna device, and an auxiliary antenna device according to an exemplary embodiment.

FIG. 2 illustrates, schematically, a main PCB of a handheld radio communication device, a main antenna device, and an auxiliary antenna device according to another exemplary embodiment.

### DETAILED DESCRIPTION

Example embodiments will now be described more fully with reference to the accompanying drawings.

Physical separation of antennas is hard to implement for smaller sized handheld radio communication devices, such as cellular phone handsets, particularly at lower frequencies such as at the LTE (Long Term Evolution) frequencies below 1 GHz. For many reasons, it is desirable to place the antennas of these devices inside the casing. This means that it is very difficult to provide a diversity solution in such a handheld communication device that has an acceptable isolation. An additional antenna will also occupy additional space in the device, which may be hard to provide because of the many other elements that it is desirable to provide in a smaller sized handheld radio communication device.

It is therefore desirable to provide an antenna solution where more than one antenna operating at the same frequency are provided in the same area and occupy essentially the same space inside the casing of the handheld radio communication device while still being able to operate at the same frequency with an acceptable low correlation. It is also desirable to provide such an antenna solution wherein all antennas have high effective antenna efficiency and small antenna efficiency difference between the antennas.

According to aspects of the present disclosure, exemplary embodiments are disclosed of an auxiliary antenna device for use in a handheld radio communication device that includes a main antenna device operatively coupled to elongated ground plane means of the communication device and configured for reception of signals at a selected frequency and polarized essentially parallel with the ground plane means. The exemplary embodiments disclosed herein may eliminate or at least alleviate the shortcomings of prior art and may thus fulfill the needs disclosed above. The auxiliary antenna device has good isolation and low correlation with respect to the main antenna device. The auxiliary antenna device has acceptable antenna efficiency and which has preferably not more than about 3 decibels (dB) efficiency difference to the main antenna device.

Exemplary embodiments are disclosed of an antenna set including an auxiliary antenna device and a main antenna device as disclosed herein. Additional exemplary embodiments include a handheld radio communication apparatus (e.g. a cellular phone handset, etc.) comprising an antenna set as disclosed herein.

According to an aspect of the present disclosure, there is provided an auxiliary antenna device for a handheld radio communication device that includes a main antenna device, preferably a monopole antenna device. The main antenna device is coupled to elongated ground plane means (essentially comprising a main PCB (Printed Circuit Board)) of the communication device. The main antenna device is configured for reception of signals at a selected frequency, preferably an LTE frequency lower than 1 GHz, and polarized essentially parallel with the elongated ground plane means. The auxiliary antenna device comprises a balanced or self-balanced antenna element arrangement configured for reception of signals at the same selected frequency as the main antenna device. But the auxiliary antenna device is polarized in a direction essentially orthogonal to the elongated ground plane means. The auxiliary antenna device also comprises an amplifier operatively connected to the balanced or self-balanced antenna element arrangement and configured for amplification of signals received by the balanced or self-balanced antenna element arrangement. The auxiliary antenna device further comprises an output port operatively connected to the amplifier, operatively connected to a radio receiver of the communication device, and configured to output, to the radio receiver, signals amplified by the amplifier.

Preferably, the main and auxiliary antennas are MIMO or MISO antennas for increased data throughput, and the auxiliary antenna is de-coupled from the elongated ground plane means by means of being a balanced or self-balanced dipole antenna. It shall be appreciated that the term self-balanced antenna is an antenna that does not induce significant currents on the ground plane means, but still has an interface that is unbalanced, i.e., the reference potential is grounded. The simplest example is a dipole antenna wherein one leg is connected to a positive terminal and the other leg is connected to ground instead of to the negative terminal, whereby, the need of a balun/transformer is avoided.

By such provisions, an antenna solution is thus obtained wherein the antennas have high isolation/low correlation as well as small antenna efficiency difference. The high isolation/low correlation is obtained by having the polarizations of the main and auxiliary antennas essentially orthogonal to one another. That is, the balanced or self-balanced antenna element arrangement should preferably extend in a direction which is essentially orthogonal to the elongated ground plane means. An envelope correlation coefficient ρ of less than 0.5 is thereby obtained.

The small antenna efficiency difference η1−η2 is obtained by the gain of the amplifier. The relatively low efficiency of the antenna element arrangement of the auxiliary antenna device can be recovered and modest efficiency drop of less than about 3 dB with respect to the main antenna device can be obtained.

In an exemplary embodiment, the antenna element arrangement of the auxiliary antenna device is a loop, folded dipole, or dipole with two ends connected to the amplifier to obtain a balanced antenna. In another exemplary embodiment, the antenna element arrangement of the auxiliary antenna device is a loop, folded dipole, or dipole with one end connected to the positive terminal of the amplifier and the other terminal connected to ground to obtain a self-balanced antenna.

According to a second aspect of the present disclosure, an antenna set for a handheld radio communication device comprising the main and auxiliary antenna devices as disclosed herein is provided. According to a third aspect of the present disclosure, a handheld radio communication device, preferably a cellular phone handset, comprising the antenna set of the second aspect as disclosed herein.

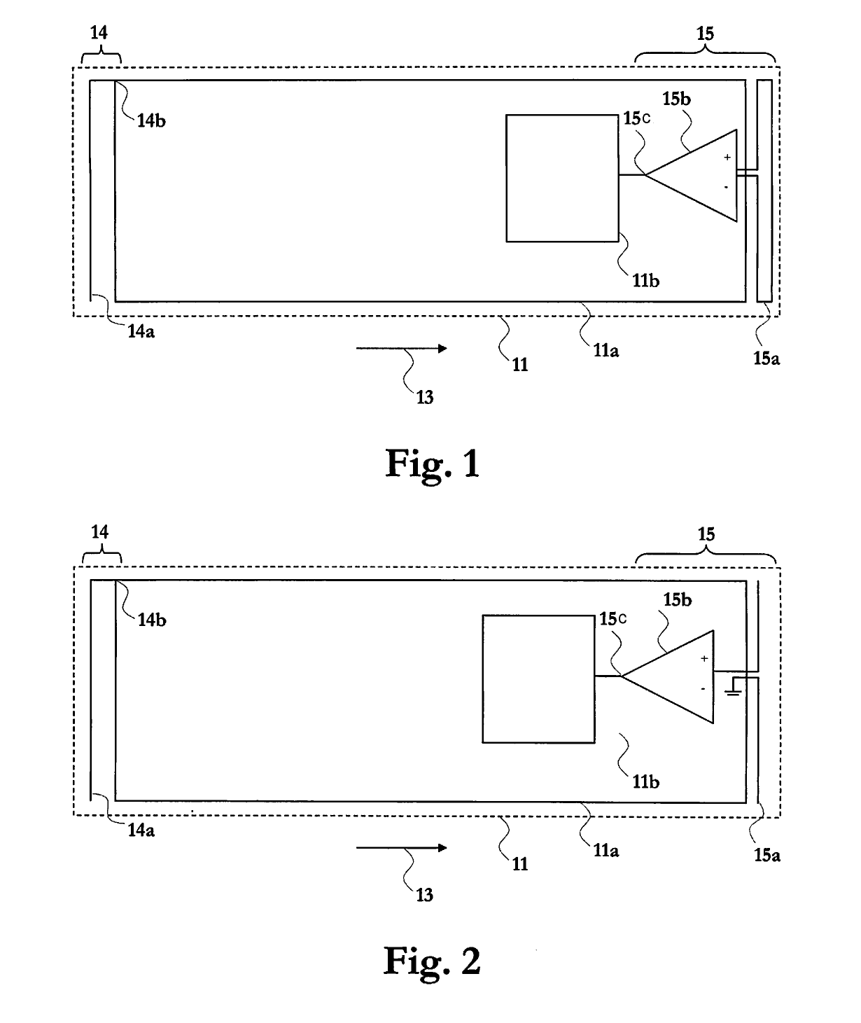

An embodiment of an auxiliary antenna device for use in a handheld radio communication device will now be described with reference to FIG. 1. The handheld radio communication device, which is typically a cellular phone handset or other handheld communication device whose dimensions are less than one wavelength of the radio communication waves, is schematically indicated by 11 in FIG. 1. The handheld radio communication device 11 comprises a main PCB 11a on which radio communication circuitry including a radio receiver 11b is arranged. The PCB 11a is elongated in a direction 13.

A main antenna device 14 is provided at a lower end of the PCB 11a when the handheld communication device 11 is held in an upright position such that the main direction 13 is essentially vertical. An auxiliary antenna device 15 is provided at an upper end of the PCB 11a when the handheld communication device 11 is held in the upright position.

The main antenna device 14 is advantageously an unbalanced antenna device having a monopole antenna element 14a and an output port 14b. The monopole antenna element 14a, which is preferably arranged below the PCB 11a when the handheld communication device 11 is held in the upright position, is operatively coupled to a ground metallic layer of the PCB 11. The ground metallic layer of the PCB 11 together with conductive parts connected thereto forms a ground plane means or ground of the handheld communication device 11. The monopole antenna element 14a is configured to receive signals at a selected frequency, preferably a frequency below 1 GHz and/or an LTE frequency such as the 750 MHz frequency for the US. Because the ground plane means mainly extends in the main direction 13, the main antenna device 14 is configured to receive signals polarized essentially in this direction. These signals are output to radio communication circuitry of the PCB 11a via the output port 14b.

The main antenna device 14 may be configured also for transmission of signals. Alternatively, the handheld communication device 11 comprises one or more separate or other antennas for transmission.

The auxiliary antenna device 15 comprises a balanced antenna element 15a configured for reception of signals at the same selected frequency. The auxiliary antenna device 15 can operate as a MIMO or SIMO antenna device for improved data throughput. The balanced antenna element 15a is de-coupled from the ground plane means and thus induces no currents therein. Further, the balanced antenna element 15a is configured to receive signals polarized in a direction essentially orthogonal to the main direction 13. This can be realized by means of the balanced antenna element 15a extending essentially in the direction orthogonal to the main direction 13. Because the auxiliary antenna device 15 should be kept within the casing of the handheld communication device 11, the available distance does not exceed the width of the handheld communication device 11, which may be 40 millimeters (mm) to 60 mm, etc. As a result, the antenna efficiency drops to unacceptable levels.

Therefore, the auxiliary antenna device 15 comprises an amplifier 15b operatively connected to the balanced antenna element 15a. The amplifier 15b is configured for amplification of signals received by the balanced antenna element 15a. The amplifier 15b is preferably a low noise differential preamplifier, such as a MESFET amplifier or a bipolar transistor, preferably a PHEMT (Pseudomorphic High Electron Mobility Transistor) amplifier, having a noise figure NF of about 1 dB. The amplifier 15b is galvanically/resistively connected to the balanced antenna element 15a and is advantageously mounted on the PCB 11a of the handheld communication device 11.

Further, the auxiliary antenna device 15 comprises an output port 15c operatively connected to the amplifier 15b and the radio receiver 11b of the handheld communication device 11. The output port 15c is configured to output signals amplified by the amplifier 15b to the radio receiver 11b.

In the embodiment illustrated in FIG. 1, the balanced antenna element 15a is a loop or folded dipole with two ends connected to the positive and negative terminals of the amplifier 15b. Alternatively, the balanced antenna element 15a can be exchanged for a balanced antenna element arrangement in the form of a dipole with two antenna elements connected to the amplifier.

Yet alternatively, the balanced antenna element 15a of FIG. 1 may be exchanged for a self-balanced antenna element arrangement. The term self-balanced antenna element arrangement is in the present context intended to describe an antenna element arrangement that does not induce significant currents on the ground plane means, but has still an interface that is unbalanced, i.e. the reference potential is grounded. FIG. 2 discloses such an example. In the embodiment illustrated in FIG. 2, the balanced antenna element is exchanged for a dipole antenna 15a. One leg of the dipole antenna 15a is connected to the positive terminal of the amplifier 15b. The other leg of the dipole antenna 15a is connected to ground instead of to the negative terminal of the amplifier 15b. In other respects, the embodiment of FIG. 2 may not differ from the embodiment of FIG. 1. The dipole antenna 15a of FIG. 2 may be exchanged for a loop or folded dipole with one end connected to the amplifier 15b and the other end connected to ground. Further, the single ended amplifier may be of different topology, e.g. a common source or common emitter amplifier.

Because the present disclosure refers principally to the auxiliary antenna device 15 disclosed above, expressions relating to mutual locations and orientations and to operation of various parts of the handheld communication device 11 refers to the auxiliary antenna device 15 being mounted and the handheld communication device 11 being used. But generally the auxiliary antenna device 15 can be manufactured and marketed by itself and/or together with the main antenna device in an antenna set. Thus, expressions above like configured, connected, coupled, arranged, and similar should generally be understood as capable of being, or intended to be, configured, connected, coupled, arranged, etc.

It shall be appreciated that the scope of the present disclosure also covers an antenna set comprising the main and auxiliary antenna devices as disclosed above as well as the handheld radio communication device 11 itself. It shall yet further be appreciated by a person skilled in the art that the auxiliary antenna device 15 can be used also for receiving GPS and/or FM signals. To this end, the handheld radio communication device 11 comprises a GPS receiver and/or an FM receiver and circuitry, e.g. including filters and/or switches, for operatively connecting the auxiliary antenna device 15 to the GPS receiver and/or the FM receiver to thereby receive GPS and/or FM signals via the auxiliary antenna device 15.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An auxiliary antenna device for a handheld radio communication device including ground plane means extending in a main direction and a main antenna device having an antenna element operatively coupled to the ground plane means and configured for reception of signals at a selected frequency and polarized essentially in the main direction, the auxiliary antenna device comprising:
a balanced or self-balanced antenna element arrangement configured for reception of signals at the selected frequency and polarized in a direction essentially orthogonal to the main direction;
an amplifier operatively connected to the balanced or self-balanced antenna element arrangement and configured for amplification of signals received by the balanced or self-balanced antenna element arrangement; and
an output port operatively connected to the amplifier and configured to output signals amplified by the amplifier.

2. The auxiliary antenna device of claim 1, wherein the selected frequency is below 1 Gigahertz (GHz) and/or a Long Term Evolution (LTE) frequency.

3. The auxiliary antenna device of claim 1, wherein the auxiliary antenna device is a MIMO (Multiple Input Multiple Output) or MISO (Multiple Input Single Output) antenna device for improved data throughput.

4. The auxiliary antenna device of claim 1, wherein the balanced or self-balanced antenna element arrangement extends essentially in the direction essentially orthogonal to the main direction.

5. The auxiliary antenna device of claim 1, wherein the balanced or self-balanced antenna element arrangement is a loop or folded dipole with two ends connected to the amplifier.

6. The auxiliary antenna device of claim 1, wherein the balanced or self-balanced antenna element arrangement is a loop or folded dipole with one end connected to the amplifier and the other end connected to the ground plane means.

7. The auxiliary antenna device of claim 1, wherein the balanced or self-balanced antenna element arrangement is a dipole with two antenna elements connected to the amplifier.

8. The auxiliary antenna device of claim 1, wherein the balanced or self-balanced antenna element arrangement is a dipole with two antenna elements, one of the two antenna elements connected to the amplifier and the other one of the two antenna elements connected to the ground plane means.

9. The auxiliary antenna device of claim 1, wherein the amplifier is a differential preamplifier.

10. The auxiliary antenna device of claim 1, wherein the amplifier comprises a MESFET amplifier, a bipolar transistor, and/or a PHEMT (Pseudomorphic High Electron Mobility Transistor) low noise amplifier.

11. An antenna set for a handheld radio communication device comprising the auxiliary antenna device of claim 1 and a main antenna device including an antenna element configured for reception of signals at the selected frequency and polarized essentially in the main direction.

12. The antenna set of claim 11, wherein the antenna element of the main antenna device is an unbalanced antenna element and/or a monopole antenna element.

13. A handheld radio communication device comprising the antenna set of claim 11, ground plane means extending in the main direction, and a radio receiver operatively connected to the output port for receiving signals amplified by the amplifier, wherein the antenna element of the main antenna device is operatively coupled to the ground plane means.

14. The handheld radio communication device of claim 13, wherein:
the ground plane means comprises a main printed circuit board (PCB);
the main antenna device is located at a lower end of the main PCB when the handheld communication device is held in an upright position such that the main direction is essentially vertical; and
the auxiliary antenna device is located at an upper end of the main PCB when the handheld communication device is held in the upright position.

15. The handheld radio communication device of claim 13, comprising:
a GPS receiver and means for operatively connecting the auxiliary antenna device to the GPS receiver to thereby receive GPS signals via the auxiliary antenna device; and/or
an FM receiver and means for operatively connecting the auxiliary antenna device to the FM receiver to thereby receive FM signals via the auxiliary antenna device.

16. An antenna set for a handheld radio communication device, the antenna set comprising:
a main antenna device including an antenna element operatively coupled to ground plane means extending in a main direction, the antenna element configured for reception of signals at a selected frequency and polarized essentially in the main direction; and
an auxiliary antenna device including:
a balanced or self-balanced antenna element arrangement configured for reception of signals at the selected frequency and polarized in a direction essentially orthogonal to the main direction;
an amplifier operatively connected to the balanced or self-balanced antenna element arrangement and configured for amplification of signals received by the balanced or self-balanced antenna element arrangement; and
an output port operatively connected to the amplifier and configured to output signals amplified by the amplifier.

17. The antenna set of claim 16, wherein:
the selected frequency is below 1 Gigahertz (GHz) and/or a Long Term Evolution (LTE) frequency;
the balanced or self-balanced antenna element arrangement extends essentially in the direction essentially orthogonal to the main direction;
the balanced or self-balanced antenna element arrangement is a loop, folded dipole, or dipole; and
the antenna element of the main antenna device is an unbalanced antenna element and/or a monopole antenna element.

18. A handheld radio communication device comprising the antenna set of claim 16, a main printed circuit board, and a radio receiver operatively connected to the output port for receiving signals amplified by the amplifier, wherein:
the ground plane means comprises the main printed circuit board (PCB); and
the antenna element of the main antenna device is operatively coupled to the main PCB.

19. A handheld radio communication device comprising:
ground plane means extending in a main direction;
a radio receiver;
a main antenna device including an antenna element operatively coupled to the ground plane means, the antenna element configured for reception of signals at a selected frequency and polarized essentially in the main direction; and
an auxiliary antenna device including:
a balanced or self-balanced antenna element arrangement configured for reception of signals at the selected frequency and polarized in a direction essentially orthogonal to the main direction;
an amplifier operatively connected to the balanced or self-balanced antenna element arrangement and configured for amplification of signals received by the balanced or self-balanced antenna element arrangement; and
an output port operatively connected to the amplifier and the radio receiver, the output port configured to output signals amplified by the amplifier to the receiver.

20. The handheld radio communication device of claim 18, wherein:
the ground plane means comprises a main printed circuit board (PCB);
the main antenna device is located at a lower end of the main PCB when the handheld communication device is held in an upright position such that the main direction is essentially vertical; and
the auxiliary antenna device is located at an upper end of the main PCB when the handheld communication device is held in the upright position.
